(19) United States
(12) Patent Application Publication
(10) Pub. No.: US 2007/0174903 A1
(43) Pub. Date: Jul. 26, 2007

(54) Method and system for managing user identities on a network

(75) Inventor: Daniel Thomas Greff, Austin, TX (US)

Correspondence Address: HICKMAN PALERMO TRUONG & BECKER, LLP;AND SUN MICROSYSTEMS, INC., 2055 GATEWAY PLACE, SUITE 550, SAN JOSE, CA, 95110-1089, US

(73) Assignee: NEOGENT, INC.

(21) Appl. No.: 11/340,124

(22) Filed: Jan. 26, 2006

(51) Int. Cl. H04L 9/32

(52) U.S. Cl. 726/6

(57) ABSTRACT

A method and system for managing user identities on a network is disclosed. form independent model for managing user identities on a network is disclosed which translated to one or more platform-specific models for the actual implementation. An trator is provided with the ability to add, modify and delete actors on the network. or, such as a help desk, is ascribed use cases, such as enabling passwords, resetting s, and disenabling passwords, that are appropriate for that actor. The administrator modify each use case, such as by unlocking a user's account before resetting the d or providing an email notification to a user prior to resetting a password, to the desired by the administrator. As a result, an actor with no or little programming skills form sophisticated identity management functions resulting in improved efficiency and lower cost to the company.

### FIELD

The method and system of the present invention pertains to the management of computer networks and, more particularly, to an improved method for managing user identities on a network.

### BACKGROUND

Managing user identities on a small network with a limited number of users, a single operating system, and a limited number of applications can be a fairly straight-forward task. For example, in a local area network (LAN) the user registry (the location where user identities are stored) is defined on each machine. That information is then replicated on each server in the domain. If the network is small enough, the system administrator can manually track all of the users identities on the network using different administration tools developed for this purpose. For example, if a new user starts work at the company, the user's account information is approved and an identity is manually created on the system. If a user takes a leave of absence, that user's identity is manually disabled upon his or her departure and manually re-enabled upon his or her return.

Unfortunately, few computer networks in this day and age are this elementary as the one described above. For example, although a company may start small, as the company grows, the number of users can proliferate. Because each user identity is typically created, altered and removed at a time that is dependant on that specific users behavior, it is rarely possible to gain efficiencies as the user population grows. Manual management of user identities quickly becomes inefficient, costly and undependable.

As computers from disparate manufacturers, or newer computer from the same manufacturer, are added to the network, it is inevitable that new operating systems will also be added. Because each operating system typically maintains its own user registry, it becomes necessary for the system administrator to learn and become proficient in managing user identities for each of the respective operating systems. Moreover, each operating system typically has its own administrative tools that allow a system administrator to add, delete, or modify user identities in the user registry, each user may require several user identities for the different operating systems on the network. As the number of users and the number of operating systems increases, management of user identities on the network becomes a daunting task.

In the prior art, administration of different user identities is typically performed using a software tool that is unique for each environment. For example, one approach to manage user identities is to use a distributed computing environment wherein the user registers with a first server and receives a set of credentials. Those credentials are then presented when accessing resources on a second computer. The second server will accept or deny the presented credentials after validating them through a series of queries. This is generally the type of user management technique employed by Windows NT. This approach is problematic when a large number of users are actively adding, deleting and modifying their identities because the second computer is (and subsequent computers are) constantly trying to stay current with the first computer. The larger the network and the greater the number of servers, the greater the problem.

Another approach is that utilized by the Windows 2000 operating system in which all applications and operating systems are forced to share a common user registry. However, implementing this approach on a network that includes several different operating systems would require that each operating system and each application be re-written to access a common user registry, a solution which is clearly not feasible.

Another complexity in the management of user identities is the increasing demands of network management. For example, there was a time when a user would call the help desk at a company to have a password reset and the help desk personnel would simply be able to click on the “reset password” button for the operating system and the user's password would be reset. In the current environment, however, other obstacles exist. For example, the user account may be locked, in which case clicking the “reset password” button will not work. In this case, because the password reset implementation resides in the software code, the help desk personnel would need to write a new program or module that calls the application program interfaces (APIs) to unlock the account. This requires a working knowledge of the programming language and the APIs necessary to unlock the account. Typical help desk support staff would not be skilled in reading and making modifications to standard programing languages. In addition, if the administrator wanted additional features, such as sending an email to the person requesting a password reset and requiring a return email prior to resetting the password, typical help desk personnel would have to send such a request to a skilled programmer.

Certain programs that address this issue to a limited degree are commercially available. For example, Sun Microsystems, Inc. makes an identiy management application that facilitates the writing of the workflow for certain identity management tasks. However, users of this product must have a fundamental understanding of standard programming languages. The application is not intended for a non-programmer and does not allow a non-programmer to efficiently and reliably manage user identities without manually writing or modifying code.

There is a need, therefore, for a method of managing user identities in the different user registries so a system administrator can, in a simple and straight-forward manner, manage the company's user identities dynamically yet in a cost effective, reliable and timely manner.

There is also a need for a method of managing user identities which increases application reuse and reduces the cost and complexity of application development and management that is portable into the future.

There is also a need for a method of managing user identities that is platform independent, thereby reducing the time, cost and complexity associated with utilizing disparate tools for different platforms.

There is also a need for a method of managing user identities that allows developers, designers and system administrators to use languages and concepts with which they, are comfortable.

### BRIEF SUMMARY OF THE INVENTION

The present invention is for an improved method and system for managing user identities on a network. An administrator is provided with the ability to add, modify and delete actors on the network. Each actor, such as a help desk, is ascribed use cases, such as enabling passwords, resetting passwords, and disenabling passwords, that are appropriate for that actor. The administrator can then modify each use case, such as by unlocking a user's account before resetting the password or providing an email notification to a user prior to resetting a password, to the extent desired by the administrator. As a result, an actor with no or little programming skills can perform sophisticated identity management functions resulting is improved efficiency and lower cost to the company

These features and advantages, as well as others, will be apparent from the following more detailed description of the preferred embodiments of the invention, as illustrated in the accompanying drawings.

### BRIEF DESCRIPTION OF THE DRAWINGS

A better understanding of the system and method of the present invention may be had by reference to the drawings, wherein:

FIG. 1 shows a screen shot showing the Select Actor Template;

FIG. 2 shows a screen shot entitled Select Actor Pattern;

FIG. 3 shows a screen shot entitled Actor Name and Description;

FIG. 4 shows a screen shot entitled Help Desk Configuration;

FIG. 5 shows a screen shot showing a screen entitled Select Usecase Template;

FIG. 6 shows a screen shot entitled Usecase Name and Description;

FIG. 7 shows a screen shot entitled Reset Password;

FIG. 8 shows a screen shot listing a set of options available for the Reset Password use case; and

FIG. 9 shows a sample of the code underlying the modifications to the Reset Password use case.

### DETAILED DESCRIPTION

The present invention is an improved method and system allowing a user to manage multiple user identities on a network. The invention can be used in managing user identities in a large corporate enterprise or can be used to manage users in a small corporate setting. Accordingly, the words “enterprise,” “corporation,” “company,” “venture” and “operation” are used interchangeably herein and can be used to describe private organizations or governmental entities. A “user” may be a human user, a file, or may be a software process that is assigned a shared resource, such as a print server. The term “network” can mean the Internet, a wide area network, a local are network or any other aggregation of more than one computer without regard to the topology of the network, the protocols used in communication on the network, or the method by which devices on the network communicate. Also, in general the term “identity” means a password, account name, personal identification number, biometric identifier, permission level or other attribute identifying or pertaining to the user in some manner.

It is important to note that while the present invention has been and will continue to be described in one embodiment as a system, those skilled in the art will appreciate that the present invention is capable of being distributed as a program product in a variety of forms, and that the present invention applies equally regardless of the particular type of media used to actually carry out the distribution. Examples of suitable media include recordable type media such as CDROM and suitable transmission mechanisms include digital and analog communications links.

The present invention provides a platform-independent model for managing user identities on a network and then translated to one or more platform-specific models for the actual implementation. To accomplish this goal, an architecture is defined that provides a set of guidelines for structuring user identity management specifications expressed as models. The translation between the platform-independent model and the platform-specific model is then performed using automated tools.

The product resulting from the above approach provides an open, vendor-neutral solution to the obstacle of inter operability between platforms. As new platforms and technologies emerge, it is possible to rapidly integrate those platforms and technologies into the existing system. As a result, the present invention provides a thorough, structured solution for portability into the future.

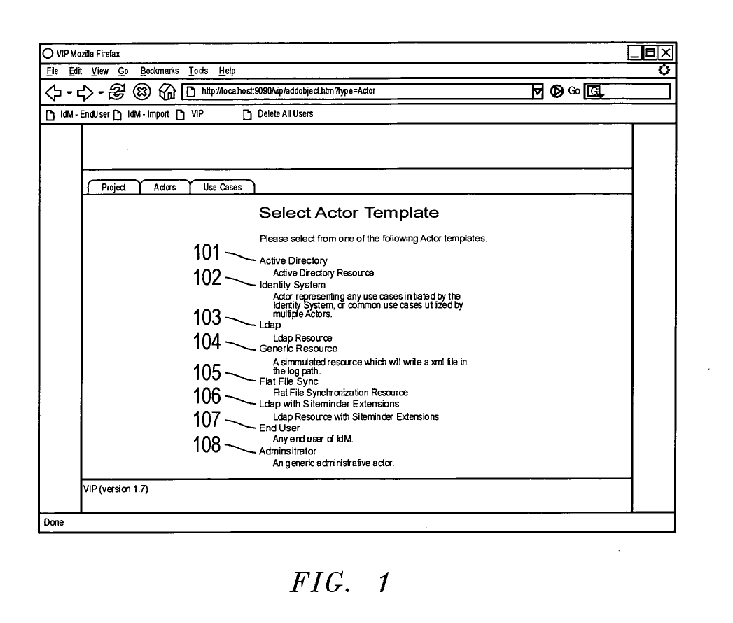

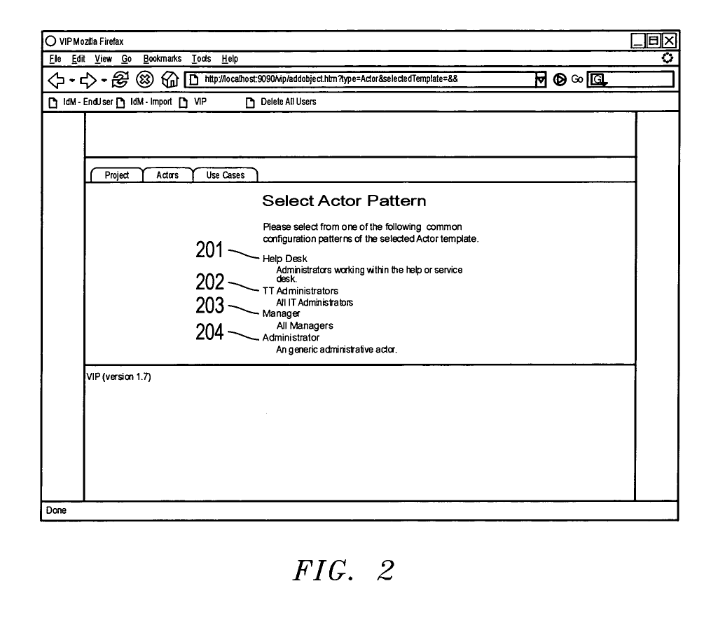

Referring now to the drawings, FIG. 1 shows a screen shot showing the Select Actor Template. In one embodiment of the invention, the administrator will begin by identifying an “actor” that will be performing the use cases. The actor can be, for example, the organization's help desk. The administrator has the option of selecting from a number of actor templates, including Active Directory 101; Identity System 102 for use with common use cases utilized by multiple actors; LDAP 103 for lightweight directory access protocol resources; Generic Resource 104 for a simulated resource; Flat File Sync 105, LDAP with site minder extensions; End User 106 for any end user of the identity management system; and Administrator 107. Any of the foregoing options may be selected by the administrator by clicking on the appropriate link.

FIG. 2 shows a screen shot entitled Select Actor Pattern. From this screen, the administrator can select from one of the more common configuration patterns for actors including Help Desk 201, IT Administrator 202, Manager 203, and Administrator 204. Again, any of the foregoing options may be selected by the administrator by clicking on the appropriate link.

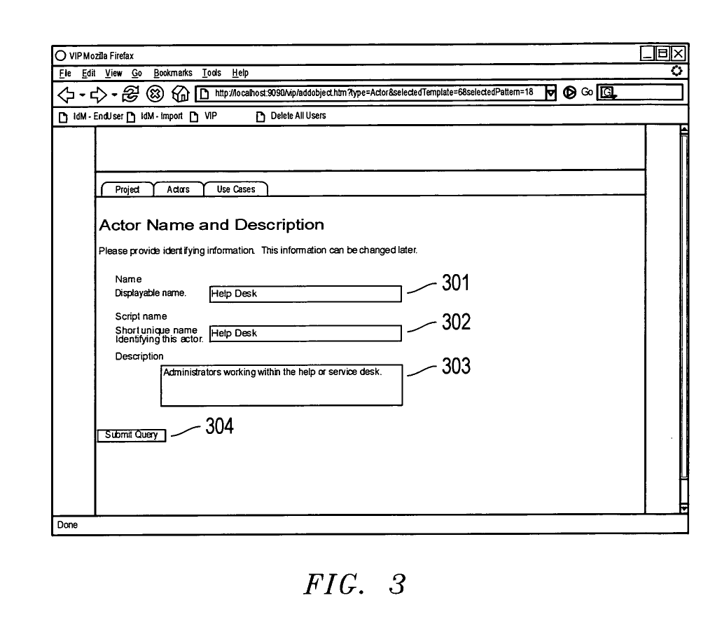

FIG. 3 shows a screen shot entitled Actor Name and Description on which the administrator can input information pertaining to the actor. Typical information includes the displayable name 301, the script name 302 and a description of the actor 303. Once this information has been input, the administrator can submit the information by clicking on the submit query button 304.

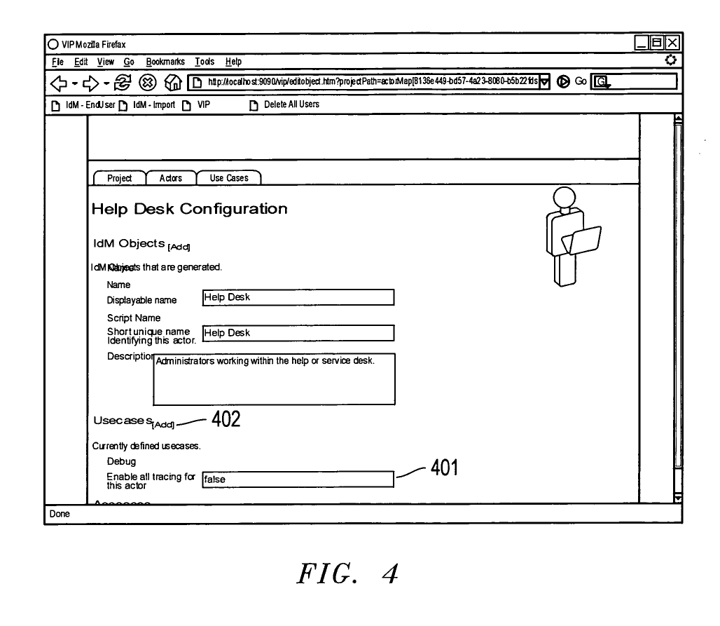

Once the actor has been identified, use cases can be assigned to that actor. FIG. 4 shows a screen shot entitled Help Desk Configuration in which use cases are identified which will be used by the Help Desk actor. The use case currently defined on the screen shown is the Debug 401 use case which enables tracing for the actor. If the use case is set to false, tracing is turned off and, conversely, if the use case is set to true, tracing is turned on. Note that limited information is shown on the static screen shot in FIG. 4 and that additional information can be obtained by the administrator by scrolling down. Also note that a link is available at the word “Add” 402 adjacent to the word “usecases” on this screen. Clicking the word “Add” 402 allows the administrator to add additional use cases to this actor.

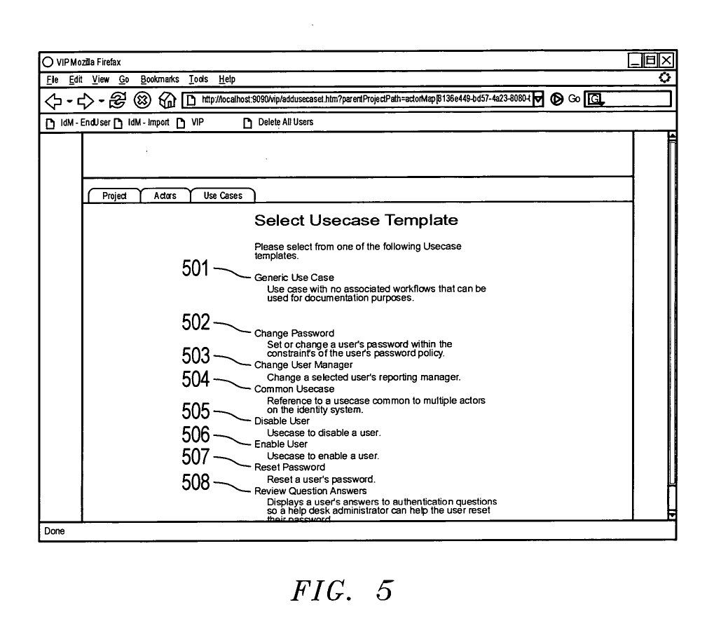

FIG. 5 is a screen shot showing a screen entitled Select Usecase Template. This screen is accessed by clicking the word “Add” 402 on the previously-described screen. From this screen, the administrator can select from a number of use case templates. For example, the administrator can select the Generic Use Case 501 which has no associated implementation but is useful for documentation purposes; Change Password 502 used to set or change a user's password; Change User Manager 503 to change a selected user's reporting manager; Common Usecases 504 which references to a usecase common to multiple actors on the identity system; Disable User 505; Enable User 506; Reset Password 507; and Review Question Answer 508. Note that, as with the previous screen, limited information is shown on the static screen shot in FIG. 5 and that additional information can be obtained by the administrator by scrolling down. Any of the foregoing options may be selected by the administrator by clicking on the appropriate link.

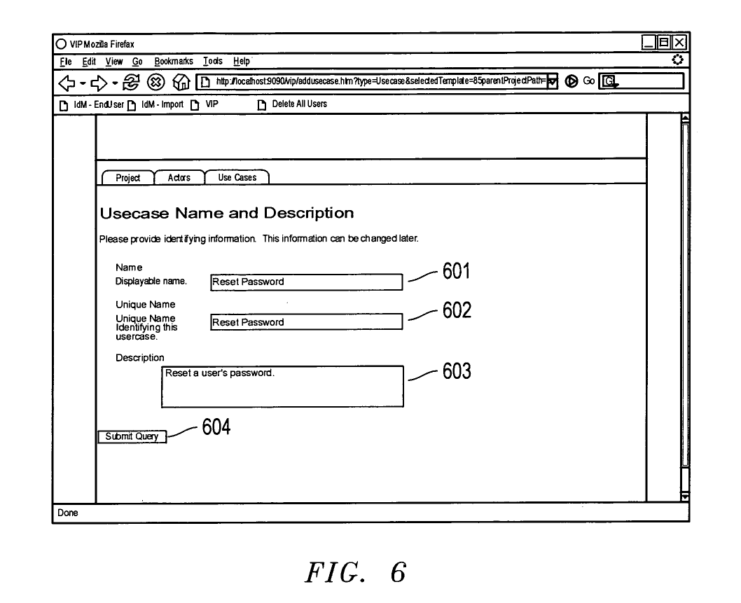

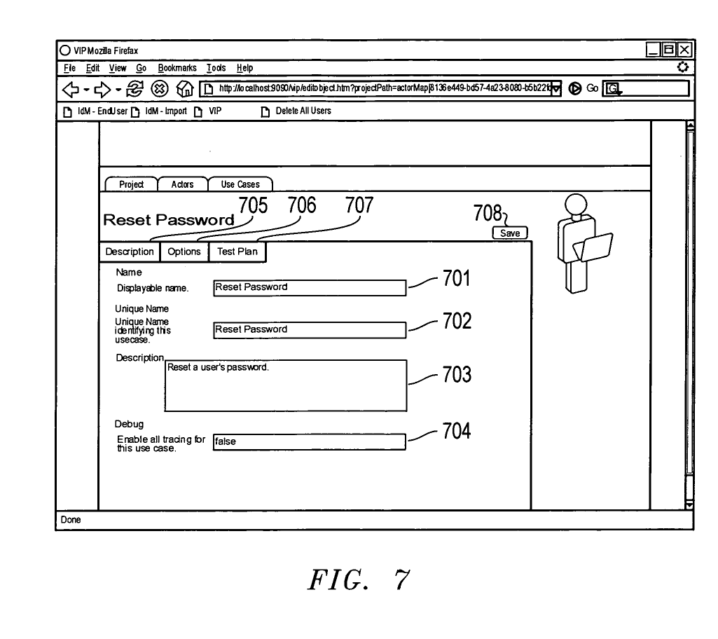

FIG. 6 shows a screen shot entitled Usecase Name and Description in which the administrator can input information pertaining to a Use Case. Typical information includes the displayable name 601, the script name 602 and a description of the actor 603. Once this information has been input, the administrator can submit the information by clicking on the submit query button 604.

If the administrator, for example, clicks on the Reset Password 507 link shown in FIG. 5, the administrator will be taken to the screen shown in FIG. 7 entitled Reset Password. Once again, typical information includes the displayable name 701, the script name 702 and a description of the actor 703. However, the administrator has the additional option of enabling or disenabling tracing for this use case by specifying true or false in the Debug 704 field. In addition, note that there are three tabs on this screen entitled Description 705, Options 706 and Test Plan 707. Once the administrator has finished providing the description of the use case under the description 705 tab, the administrator can select additional options for the use case under the options 706 tab or identify a test plan for the use case by clicking on the Test Plan 707 tab. After all of the desired changes have been made to the use case, the administrator can click on the Save button 708 to save the changes.

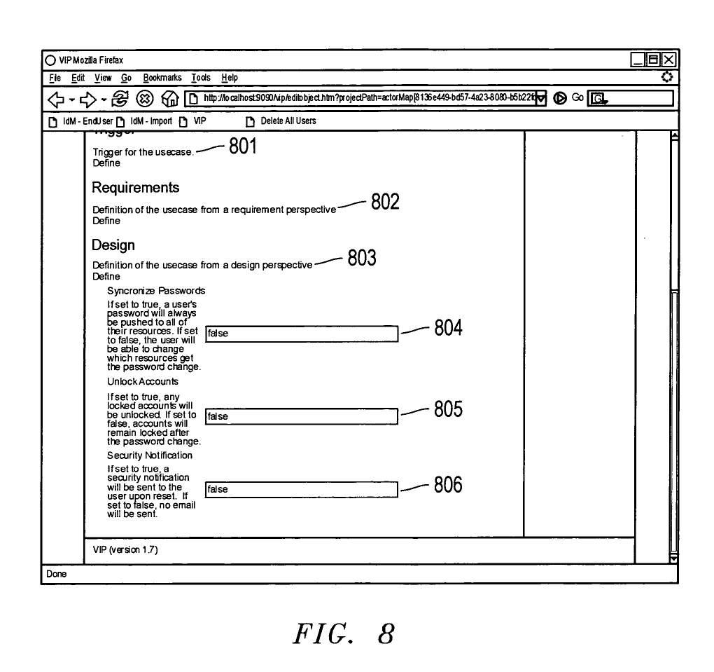

If the administrator selects the options 706 tab on the screen shown in FIG. 7, the screen shown in FIG. 8 appears which contains a list of options possible for the use case. Visible on the static screen shot are trigger 801 which include modifiable variables for the use case trigger; requirements 802 which includes modifiable variables related to the use case requirements; and design 803 which includes modifiable variables from the design perspective such as allowing the administrator to set parameters related to synchronize passwords 804, unlock accounts 805 and security notification 806. Note that, as with the previous screens, limited information is shown on the static screen shot in FIG. 8 and that additional changes can be made to the use case by scrolling up or down.

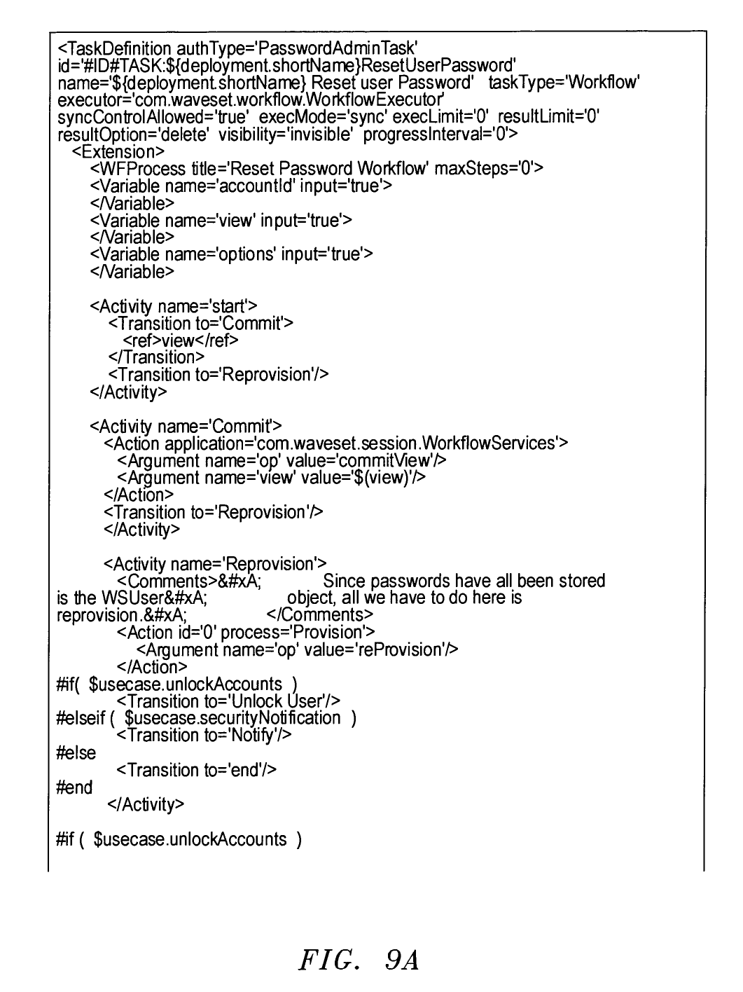

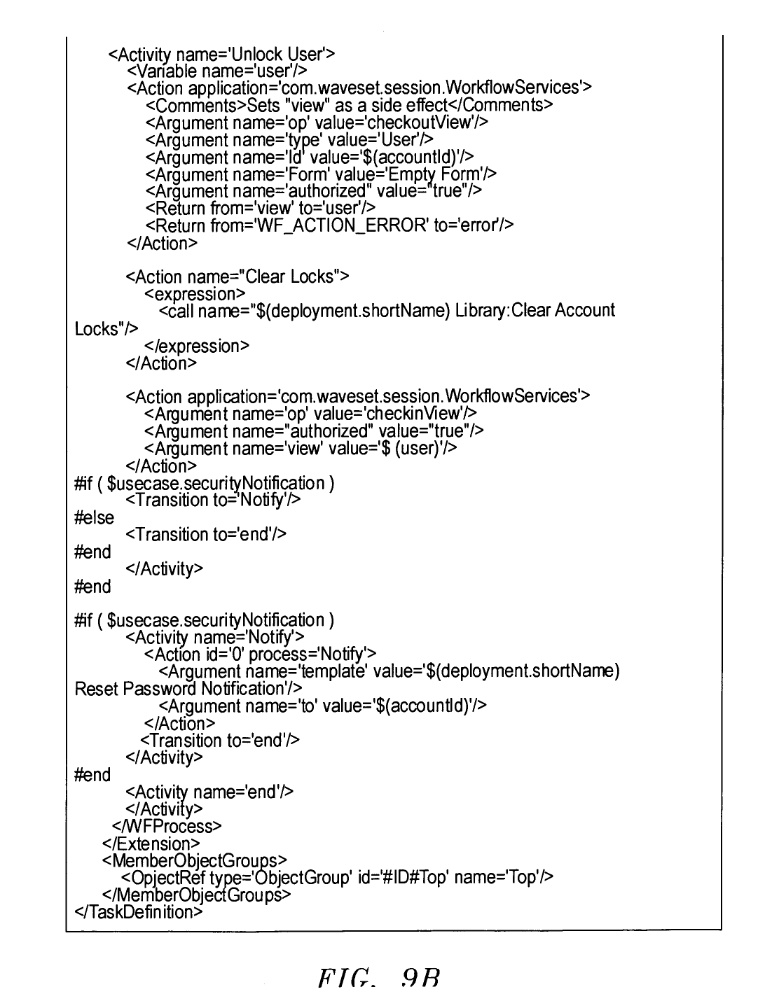

Once the use case information has been modified, an implementation of the Reset Password use case is generated. The resulting implementation is vendor-specific, but the Administrator may choose which implementation to generate. FIG. 9 shows a sample of the code from a specific vendor underlying the modifications to the Reset Password use case presented in the foregoing illustrative screen shots.

It is important to note that the foregoing discussion describes one embodiment of the invention. For example, while the actor in the foregoing discussion was a company's help desk, the actor could alternatively be a end user such as any non-administrative user requiring identity management functionality. In such a case, use cases may be, for example, reset password enabling the end user to reset a forgotten password; change password enabling the end user to change their password; access request enabling the end user to access information technology resources; change answers enabling the end user to answer their authentication questions used during the Reset Password process; Change Information enabling the end user to change personal information; and Create User Request enabling the end user to make requests which are subsequently approved by the administrator or others.

As another example, the actor could be designated as HR Synchronization which could automatically initiate provisioning events based on changes in an employee's human resources data. In this case, use cases may be, for example, Create User enabling the end user to create a new user account; Update User enabling the end user to update the user's account; Rename User enabling the end user to rename the user's account; Disable User enabling the end user to disable the user's account; and Delete User enabling the end user to delete the user's account.

There are numerous additional use cases for the actors described herein and there are numerous additional actors which can be designated for any organization. The specific actors and use cases described herein are not meant to be limiting and are meant only to serve as examples of the types of actors and use cases that may be used in connection with the present invention.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible actors and use cases, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for managing user identities on a network comprising:
allowing a network administrator within an enterprise to add, modify or delete at least one actor to be involved in the management of user identities on a network;
permitting said at least one actor to perform at least one use case;
modifying said at least one use case as desired by said network administrator; and
implementing said at least one use case on said network by said at least one actor.

2. The method of claim 1 wherein said enterprise is a corporation, a company, a venture or an operation, whether governmental or private.

3. The method of claim 1 wherein said at least one actor is one or more of a human user, a file, or a software file assigned to share a resource.

4. The method of claim 1 wherein the network is a local area network, a wide area network, or the Internet.

5. The method of claim 1 wherein said at least one use case is one or more of enabling a password, disabling a password, resetting a password, changing a password and changing a user's manager.

6. The method of claim 1 wherein said modification is synchronizing the password, unlocking an account or providing security notification.

7. The method of claim 1 wherein said implementation is platform independent.

8. A system for managing user identities on a network comprising:
a network in an enterprise managed by a network administrator, wherein said network administrator can add, modify or delete at least one actor to be involved in the management of user identities on said network;
said at least one actor being permitted to perform at least one use case, wherein said at least one use case is modified as desired by said network administrator; and
implementing said at least one use case on said network by said at least one actor.

9. The system of claim 8 wherein said enterprise is a corporation, a company, a venture or an operation, whether governmental or private.

10. The system of claim 8 wherein said at least one actor is one or more of a human user, a file, or a software file assigned to share a resource.

11. The system of claim 8 wherein the network is a local area network, a wide area network, or the Internet.

12. The system of claim 8 wherein said at least one use case is one or more of enabling a password, disabling a password, resetting a password, changing a password and changing a user's manager.

13. The system of claim 8 wherein said modification is synchronizing the password, unlocking an account or providing security notification.

14. The system of claim 8 wherein said implementation is platform independent.

15. A method for managing user identities on a network comprising:
means for a network administrator within an enterprise to add, modify or delete at least one actor to be involved in the management of user identities on a network;
means for said at least one actor to perform at least one use case;
means for modifying said at least one use case as desired by said network administrator; and
means for implementing said at least one use case on said network by said at least one actor.

16. The method of claim 15 wherein said enterprise is a corporation, a company, a venture or an operation, whether governmental or private.

17. The method of claim 15 wherein said at least one actor is one or more of a human user, a file, or a software file assigned to share a resource.

18. The method of claim 15 wherein the network is a local area network, a wide area network, or the Internet.

19. The method of claim 15 wherein said at least one use case is one or more of enabling a password, disabling a password, resetting a password, changing a password and changing a user's manager.

20. The method of claim 15 wherein said modification is synchronizing the password, unlocking an account or providing security notification.

21. The method of claim 15 wherein said implementation is platform independent.
